(19) United States
(12) Patent Application Publication
(10) Pub. No.: US 2023/0173508 A1
(43) Pub. Date: Jun. 8, 2023

(54) Nanoparticle Mass Purification System and Nanoparticle Mass Purification Method Using Same

(71) Applicant: HANSOL CHEMICAL CO.,LTD., Seoul (KR)

(72) Inventors: Sungmin HA, Jeollabuk-do (KR); Jaewoo SHIN, Jeollabuk-do (KR); Kwangdeok LEE, Jeollabuk-do (KR); Chunrae NAM, Jeollabuk-do (KR)

(21) Appl. No.: 17/995,509

(22) PCT Filed: Apr. 9, 2020
(86) PCT No.: PCT/KR2020/004850

§ 371 Date: Oct. 5, 2022

(30) Foreign Application Priority Data
Apr. 7, 2020 (KR) 10-2020-0042375

(51) Int. Cl. B04B 5/10; B01D 3/32; B04B 1/12; B04B 15/00; B04B 13/00; B01D 21/26; B01D 21/34

(52) U.S. Cl. CPC B04B 5/10; B01D 3/32; B01D 21/34; B01D 21/262; B04B 1/12; B04B 13/00; B04B 15/00; B82Y 40/00

(57) ABSTRACT

The present invention provides a nanoparticle mass purification system capable of purifying nanoparticles at high yield and high purify from a nanoparticle synthesis stock solution synthesized in large quantities, and reusing the used solvent by recovery, and a nanoparticle mass purification method using same.

### CROSS-REFERENCE TO RELATED APPLICATIONS

This application is a U.S. National Stage Application under 35 U.S.C. § 371 of International Patent Application No. PCT/KR2020/004850 filed Apr. 9, 2020 (published as WO2021206196A1), which claims the benefit of priority of Korean Patent Application No. KR10-2020-0042375 filed Apr. 7, 2020, both of which are incorporated by reference in their entireties.

### TECHNICAL FIELD

The present invention relates to a nanoparticle mass purification system and a nanoparticle mass purification method using the nanoparticle mass purification system, and more particularly, to a nanoparticle mass purification system capable of purifying nanoparticles from a crude solution for nanoparticle synthesis synthesized in large quantity, and reusing a used solvent by recovery, and a nanoparticle mass purification method using same.

### BACKGROUND ART

Nanotechnology is a technology for synthesizing, assembling, and controlling materials in a small size unit such as an atom or a molecule, and identifying their properties. In general, it refers to a technology for a material or object in a range of 1 to 100 nanometers.

The nanotechnology has unique optical and chemical properties by virtue of the size of nanoparticles, and exhibits excellent mechanical and electrical properties, thus having been applied in various fields. In particular, nanotechnology is being applied to various fields ranging from electronics, communication, materials/manufacturing, medical, biotechnology, environment/energy, and aviation, and accordingly, a process for synthesizing nanoparticles in a large amount in a liquid phase is being actively developed.

Meanwhile, since various impurities may remain when nanoparticles are synthesized, the unique properties of nanoparticles may be exhibited only through a purification process for removing these impurities to increase the purity of nanoparticles. Conventionally, techniques such as ultrafiltration have been used, but these techniques have various problems in that they are costly and time-consuming, cause poor pore size due to adhesions, depend on specific substances, experience degradation of physical properties over time, or the like. In addition, a technique of precipitating and recovering nanoparticles using a centrifuge and dispersing them in a solvent free of impurities was also used. Most of the nanoparticle purification methods described above are of a batch type, and they are not suitable for mass production. In particular, since the conventional centrifuge has a manipulatable volume of less than 10 liters, it was mainly used on a laboratory scale, and it was difficult to apply to a mass (e.g., large-capacity) purification process. In addition, since the work process is performed manually, there is a limit to securing a large quantity of quantum dots of uniform quality. Accordingly, there is a need for a technology capable of purifying a large amount of nanoparticles more efficiently.

### SUMMARY OF THE DISCLOSURE

The present invention has been devised to address the above problems and is directed to a nanoparticle mass purification system capable of continuously and efficiently purifying high-purity nanoparticles from a crude solution for nanoparticle synthesis by including a plurality of continuous centrifuges.

The present invention is also directed to a nanoparticle mass purification method using the nanoparticle mass purification system.

The present invention is also directed to a nanoparticle mass purification method capable of re-adjusting desired physical properties through separation and control of a fine size (e.g., an average particle diameter) of nanoparticles during the above-described purification process.

Other objectives and advantages of the present invention may be more clearly explained by the following detailed description and claims.

In order to achieve the above technical objectives, the present invention provides a system of purifying nanoparticles including: a first mix tank configured to prepare a first reaction mixture by mixing a crude solution for nanoparticle synthesis and a first mix solvent; a first continuous centrifuge configured to primarily separate nanoparticles and a first filtrate by centrifuging the first reaction mixture supplied from the first mix tank; a second mix tank configured to prepare a second reaction mixture by mixing the first filtrate supplied from the first continuous centrifuge and a second mix solvent; and a second continuous centrifuge configured to secondarily separate the nanoparticles and a second filtrate by centrifuging the second reaction mixture supplied from the second mix tank.

In an embodiment of the present invention, the system of purifying nanoparticles may further include a third mix tank configured to prepare a third reaction mixture by mixing the second filtrate supplied from the second continuous centrifuge and a third mix solvent.

In an embodiment of the present invention, the system of purifying nanoparticles may further include a distillation device configured to separate, in a distillation manner, a mix solvent and the nanoparticles from the third reaction mixture of the third mix tank or from the second filtrate separated by the second continuous centrifuge.

In an embodiment, the distillation device may include: a distillation heat exchanger to which the third reaction mixture or the second filtrate is supplied; and at least one heater disposed in contact with the distillation heat exchanger.

In an embodiment of the present invention, the system of purifying nanoparticles may further include at least one solvent storage tank connected to the distillation device and configured to store a solvent recovered by distillation.

In an embodiment of the present invention, the system of purifying nanoparticles may further include a plurality of solvent supply tanks, wherein the solvent storage tank may be connected to at least one of the plurality of solvent supply tanks and the first to third mix tanks such that the recovered solvent may be reused.

In an embodiment of the present invention, the system of purifying nanoparticles may further include a monitoring unit installed at a predetermined position in a pipe where the first continuous centrifuge and the second mix tank are connected.

In an embodiment of the present invention, each of the first continuous centrifuge and the second continuous centrifuge may include an inert gas supply for supplying an inert gas into the first continuous centrifuge and the second continuous centrifuge.

The present invention further provides a method of purifying nanoparticles including: (i) preparing a first reaction mixture by mixing a crude solution for nanoparticle synthesis and a first mix solvent; (ii) primarily separating nanoparticles and a first filtrate from the first reaction mixture using a continuous centrifuge; (iii) preparing a second reaction mixture by mixing the first filtrate and a second mix solvent; and (iv) secondarily separating the nanoparticles and a second filtrate from the second reaction mixture using a continuous centrifuge.

In an embodiment of the present invention, in step (i), the crude solution for nanoparticle synthesis may include the nanoparticles and a solvent having a high boiling point of 200° C. or higher.

In an embodiment of the present invention, each of the first mix solvent and the second mix solvent may be a mixture of a non-solvent in which the nanoparticles are not dispersible, or a mixture of a non-solvent and an organic solvent.

In an embodiment of the present invention, each of the first mix solvent and the second mix solvent may be a mixture of acetone and ethanol.

In an embodiment of the present invention, in the first reaction mixture in step (i), a mixing ratio of the crude solution for nanoparticle synthesis, acetone and ethanol may be in a range of 1 to 4 : 1 to 2 : 4 to 12 by volume.

In an embodiment of the present invention, in the second reaction mixture in step (iii), a mixing ratio of the first filtrate, acetone and ethanol may be in a range of 1 to 3 : 1 to 2 : 4 to 12 by volume.

In an embodiment of the present invention, the first mix solvent in step (i) or the second mix solvent in step (iii) may further include 1 to 10 percent by weight (wt%) of an inorganic material with respect to the total weight of ethanol in the corresponding mix solvent.

In an embodiment of the present invention, the inorganic material may be a metal halide including at least one of Zn, Mg, and Al, or an aqueous solution including the metal halide.

In an embodiment of the present invention, the continuous centrifuges in steps (ii) and (iv) may be operated under conditions of: a reaction mixture input amount per minute in a range of 4 to 6 L/min; a G value in a range of 13,000 to 16,000 g; and a rotational speed in a range of 13,000 to 16,000 rpm.

In an embodiment of the present invention, each of the first continuous centrifuge and the second continuous centrifuge may centrifuge under an inert atmosphere by supplying a nitrogen gas into each of the first continuous centrifuge and the second continuous centrifuge.

In an embodiment of the present invention, the method may further include, after step (iv): (v) preparing a third reaction mixture by mixing the second filtrate and a third solvent; and (vi) tertiarily separating the nanoparticles and a solvent by distilling the third reaction mixture.

In an embodiment of the present invention, the method may further include, after step (vi): (vii) recovering the separated solvent and reusing the recovered solvent as a solvent of at least one of steps (i), (iii) and (v).

According to an embodiment of the present invention, nanoparticles may be purified with high purity at high yield from a crude solution for nanoparticle synthesis (e.g., a mixture) that is synthesized in large quantity of 200 L or more within a predetermined process time.

In addition, in the present invention, since a large amount of an organic solvent used in the purification process may be recovered and reused, it is useful, economical, and environmentally friendly in terms of organic wastewater treatment.

In addition, in the present invention, it is possible to mass-produce nanoparticles through a continuous nanoparticle purification system.

The effect according to the present invention is not limited by descriptions exemplified above, and more various effects are incorporated in the present specification.

### BRIEF DESCRIPTION OF DRAWINGS

FIG. 1 is a schematic diagram illustrating a nanoparticle purification system according to an embodiment of the present invention.

FIG. 2 is a process flow chart illustrating a nanoparticle purification method using the purification system of FIG. 1.

FIG. 3 is a schematic diagram illustrating a nanoparticle purification system according to another embodiment of the present invention.

FIG. 4 is a process flow chart illustrating a nanoparticle purification method using the purification system of FIG. 3.

### DETAILED DESCRIPTION

Hereinafter, preferred embodiments of the present invention will be described in detail with reference to the accompanying drawings. Embodiments of the present invention are provided to more completely illustrate the present invention to those of ordinary skill in the art, and the following embodiments may be modified in various other forms, and the scope of the present invention is not limited to the following embodiments. Herein, the same reference numerals refer to the same structures throughout this specification.

Unless otherwise defined, all terms (including technical and scientific terms) used herein may be used with the meaning commonly understood by those of ordinary skill in the art to which the present invention belongs. In addition, terms defined in a commonly used dictionary are not to be interpreted ideally or excessively unless clearly defined in particular.

Herein, the size and thickness of each element illustrated in the drawings are arbitrarily indicated for convenience of description, and the present invention is not necessarily limited to the illustrated. In order to clearly express various layers and regions in the drawings, the thicknesses are enlarged. In the drawings, for convenience of explanation, the thickness of some layers and regions is exaggerated.

Throughout the specification, when a part “includes” a certain component, this means that another component may be further included, rather than excluding another component, unless otherwise stated. In addition, throughout the specification, “on” or “above” means not only when it is located above or below the target part, but also includes the case where there is another part in the middle therebetween, and it does not mean that it is positioned thereabove with respect to the direction of gravity. As used herein, terms such as “first” and “second” do not indicate any order or importance, but are used to distinguish components from each other.

In addition, the terms “about,” “substantially,” and the like, to the extent used herein, are used in their meaning at or close to those numbers when presented with manufacturing and material tolerances inherent in the stated meaning, and it is used to prevent an unconscionable infringer from using the disclosure in which exact or absolute figures are mentioned to help the understanding of the present disclosure. The term “step of” or “stage of” as used throughout this specification does not mean “step for”.

Throughout this specification, “nanoparticles NP” may refer to conventional quantum dots (QD) known in the art. Specifically, quantum dots may refer to nano-sized semiconductor materials, and these quantum dots may have a homogeneous single-layer structure; a multi-layer structure such as a core-shell shape, a gradient structure, and the like; or a combined structure thereof. However, it is not particularly limited to the above-described quantum dots, and it is also within the scope of the present invention to include all objects or materials in a range of 1 to 100 nanometers in the art.

Hereinafter, a nanoparticle mass purification system according to an embodiment of the present invention will be described in detail with reference to the accompanying drawings.

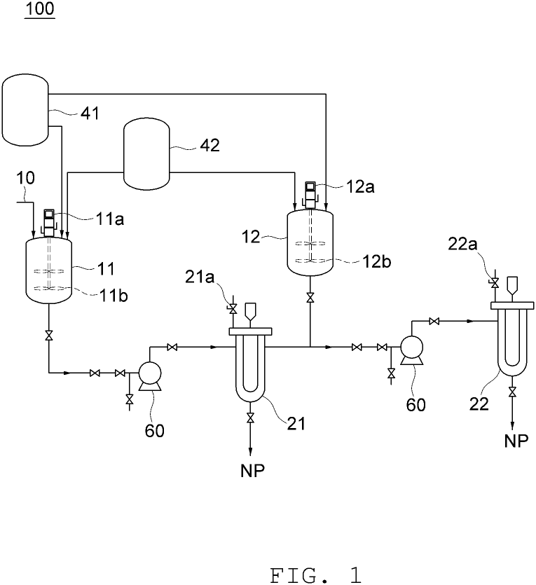

FIG. 1 is a schematic diagram illustrating a nanoparticle purification system 100 according to an embodiment of the present invention.

Referring to FIG. 1, a nanoparticle purification system 100 according to an embodiment of the present invention, which is a mass (e.g., large-capacity, large-quantity, etc.) purification system for continuously separating and purifying nanoparticles from a crude solution for nanoparticle synthesis (e.g., a nanoparticle synthetic undiluted solution) including various components, includes a plurality of continuous centrifuges 21 and 22 to perform continuous centrifugation at least two times.

Specifically, in the present invention, while nanoparticles are purified in a continuous process using a conventional centrifuge for wastewater treatment, the nanoparticles may be purified at high yield by using a weight of the nanoparticles and a difference in solubility between solvents.

That is, in the conventional centrifuge for wastewater treatment, a solid filtered from a wastewater that has passed through the centrifuge may be a waste, whereas in the present invention, a solid collected in a bowl after a nanoparticle and solvent containing dispersion (e.g., first and second reaction mixtures) passes through a continuous centrifuge may be expensive nanoparticles. In particular, some of the nanoparticles may pass through the continuous centrifuge even though a g value of the continuous centrifuge is very high, and accordingly, there is a limit in purifying the nanoparticles at high yield when they are separated by a single continuous centrifuge. Accordingly, the nanoparticle mass purification system according to the present invention is provided with a plurality of, for example, at least two continuous centrifuges 21 and 22, thereby capable of obtaining high-quality nanoparticles at a high yield of 95 % or more, preferably in a range of 95 to 98 % (see Tables 1-2 below).

Referring to FIG. 1, the nanoparticle purification system 100 includes a first mix tank 11, a first continuous centrifuge 21, a second mix tank 12, a second continuous centrifuge 22, a plurality of solvent supply tanks 41 and 42, and a transfer pump 60.

Hereinafter, each component of the nanoparticle purification system described below may use a light-blocking material to prevent photodegradation or photodeteriation of nanoparticles NP, for example, quantum dots (QD). As the material, any metal, alloy, or ceramic material known in the art may be used without limitation, and specifically may be a SUS tubing material.

The first mix tank 11 may uniformly mix a crude solution for nanoparticle synthesis 10 and a first mix solvent to produce a first reaction mixture. To this end, the first mix tank 11 is provided with at least two inlets and outlets, specifically, at least three inlets and outlets, and a stirrer and a stirring motor are provided therein.

In a specific example, the first mix tank 11 may include an inlet through which the crude solution for nanoparticle synthesis 10 is introduced through a pipe; a plurality of inlets through which the first mix solvent is introduced from at least one of the solvent supply tank 41, 42; a first stirrer 11b disposed in an inner central portion of the first mix tank 11 to mix the crude solution for nanoparticle synthesis and the first mix solvent; a first stirring motor 11a coupled to an upper or lower portion of the first mix tank 11 to transmit a rotational force to the first stirrer 11b; and an outlet for discharging a first reaction mixture (e.g., a first reaction mixed solution) formed by mixing the crude solution for nanoparticle synthesis 10 and the first mix solvent.

The crude solution for nanoparticle synthesis 10 is a stock solution (e.g., an undiluted solution) prepared during an initial synthesis of nanoparticles, and includes various materials and solvents required to control size and/or structure of the nanoparticles. The solvent contained in the crude solution for nanoparticle synthesis 10 may be a conventional high boiling point solvent known in the art used for nanoparticle synthesis, for example, having a boiling point of 200° C. or higher, and it may specifically be an organic solvent having a boiling point in a range of 300 to 400° C. Specific examples of such a high boiling point solvent may include alkyl phosphine having 6 to 22 carbon atoms, alkyl phosphine oxide having 6 to 22 carbon atoms, alkyl amine having 6 to 22 carbon atoms, alkane having 6 to 22 carbon atoms, alkene having 6 to 22 carbon atoms, or a mixture of at least two or more thereof.

Meanwhile, nanoparticles prepared by wet chemical synthesis are dispersed in a solvent, in a colloidal state. In order to separate the nanoparticles from the solvent through centrifugation, a non-solvent is added to and uniformly mixed with the crude solution for nanoparticle synthesis 10.

As a specific example, the first mix solvent may be at least one type of non-solvent mix solvent in which nanoparticles contained in the crude solution for nanoparticle synthesis 10 are not dispersible, or a mix solvent in which the non-solvent is mixed with an organic solvent. For example, the first mix solvent may include acetone and a lower alcohol having 1 to 6 carbon atoms, and more specifically, acetone and ethanol.

In the present invention, it was recognized that fine control (e.g., precise control) of a mixing ratio between the solvent and the non-solvent added to the plurality of mix tanks 11 and 12 during the continuous mass purification process within a predetermined range may achieve effects of promoting solidification of nanoparticles and removing the high boiling point solvent and by-products, and that control of centrifugation conditions (e.g., a g value) of the plurality of continuous centrifuges 21 and 22 at the same time may further achieve effects of purifying high-purity and high-quality nanoparticles at high yield.

In particular, in the present invention, photoluminescence (PL) characteristics of the recovered nanoparticles may be adjusted within a limited range, approximately in a range of 2 to 4 nm, by finely controlling the mixing ratio between the solvent and the non-solvent described above.

That is, when a use amount of the non-solvent, such as ethanol, is increased in the mixing ratio of the solvent and the non-solvent, the yield of the nanoparticles may be partially increased, whereas the photoluminescence (PL) of the recovered nanoparticles may be outside the desired range, and this may lead to a decrease in the quality of nanoparticles (e.g., a decrease in quantum efficiency). In contrast, in the present invention, by finely controlling the amount of ethanol used within a specific range (e.g., 4 to 12 volume ratio) and including at least two continuous centrifuges 21 and 22, the photoluminescence (PL) wavelength of nanoparticles may be finely adjusted through blue shift, red shift, or the like, thereby achieving an advantage that nanoparticles suitable for the desired photoluminescence wavelength condition may be obtained with a maximum high yield.

In the present invention, it is necessary to finely control the mixing ratio between the solvent and the non-solvent added to the first mix tank 11 within a predetermined range in consideration of the high purity, high yield, and photoluminescence (PL) characteristics of the nanoparticles described above.

As a specific example, the mixing ratio of the crude solution for nanoparticle synthesis 10, acetone and ethanol constituting the first reaction mixture may be in a range of 1 to 4 : 1 to 2 : 4 to 12 by volume, specifically 1 to 4 : 1 : 4 to 12 by volume, and more specifically 3 : 1 : 6 by volume.

The first reaction mixture uniformly mixed in the first mix tank 11 is transferred to the first continuous centrifuge 21 at a constant flow rate through the transfer pump 60.

The first continuous centrifuge 21 is connected to the first mix tank 11 and primarily separate the nanoparticles NP and a first filtrate by centrifuging the first reaction mixture supplied from the first mix tank 11.

The first continuous centrifuge 21 may use a conventional continuous centrifuge known in the art without limitation, and may be, for example, a centrifuge for wastewater treatment. In particular, in the present invention, for mass purification, the continuous centrifuges 21 and 22 in which a size of a bowl is maximized may be used. A capacity of the first continuous centrifuge 21 may be in a range of 4 to 8 liters, specifically in a range of 5 to 7 liters, and more specifically in a range of 5.5 to 6 liters, with respect to the size of the bowl for collecting solids. However, the present invention is not particularly limited thereto. In addition, in order to effectively recover the nanoparticles, it is necessary to transfer the bowl, so it is preferable to use a material having a relatively light weight. The first continuous centrifuge 21 may use a conventional metal material known in the art, and may be preferably made of a lightweight metal material such as SUS304 and/or titanium.

Meanwhile, the solvent and the non-solvent (e.g., the mix solvent) used to remove the high-boiling solvent contained in the crude solution for nanoparticle synthesis 10 are mostly organic solvents, and when a high-speed continuous centrifugation is performed in a state where such an organic solvent is filled, fine mist may occur to cause, for example, fire or odor. To prevent this, in the present invention, an inert gas supply 21a for introducing an inert gas to an upper end or a lower end of the first continuous centrifuge 21 may be provided. As the inert gas input to the inert gas supply 21a, any inert gas known in the art may be used without limitation, for example, a nitrogen gas (N₂) may be used.

Most of nanoparticles NP primarily separated through the first continuous centrifuge 21 are recovered, and residual nanoparticles are transferred to the second mix tank 12 while being contained in the first filtrate.

In the present invention, in order to monitor nanoparticles NP that have passed through without precipitation, although the operating conditions (e.g., the G value, rpm, input per minute, time, etc.) of the first continuous centrifuge 21 are strictly controlled within a predetermined range, a monitoring unit (not illustrated) for checking a flow of the nanoparticles being transferred may be installed at a predetermined position of a pipe where the first continuous centrifuge 21 and the second mix tank 12 are connected. The monitoring unit is not particularly limited in size, structure, shape, and the like as long as the flow of the first filtrate including nanoparticles may be visually confirmed. For example, it may be a transparent window. The transparent window may be made of a transparent material known in the art, and for example, transparent plastic or quartz may be used.

The second mix tank 12 is connected to the first continuous centrifuge 21 and uniformly mixes the first filtrate filtered from the first continuous centrifuge 21, and a second mix solvent to remove secondary by-products and produce a second reaction mixture. For the second mix tank 12, the description of the above-described first mix tank 11 may be applied as it is.

As the second mix solvent input to the second mix tank 12, a non-solvent mix solvent may be used as the first mix solvent, and for example, acetone and ethanol may be used. However, a mixing ratio between the non-solvent and the solvent constituting the second reaction mixture may be adjusted to be different from the mixing ratio of the first reaction mixture.

For example, the mixing ratio of the first filtrate, acetone and ethanol constituting the second reaction mixture may be in a range of 1 to 3 : 1 to 2 : 4 to 12 by volume, specifically in a range of 1 to 3 : 1 : 4 to 12 by volume, and more specifically in a range of 3 : 1 : 5 by volume.

The second reaction mixture uniformly mixed in the second mix tank 12 is transferred to the second continuous centrifuge 22 at a constant flow rate through the transfer pump 60, and then secondarily separated into the nanoparticles NP and a second filtrate by centrifugation.

A capacity of the second continuous centrifuge 22 is not particularly limited, and may have, for example, a capacity equal to or greater than that of the first continuous centrifuge. Specifically, it may be in a range of 7 to 12 liters, specifically in a range of 8 to 10 liters, and more specifically in a range of 8.5 to 9.5 liter, with respect to a size of a bowl for collecting solids. In addition, operating conditions of the second continuous centrifuge 22 are preferably adjusted within a predetermined range to be described below in order to effectively remove the secondary by-products.

The nanoparticle purification system 100 according to the present invention may include, in order to increase a recovery rate of nanoparticles, a non-solvent inlet (not illustrated) installed at an upper end or a lower end of the second continuous centrifuge 22, or at a predetermined position of a pipe to which the second continuous centrifuge 22 is connected.

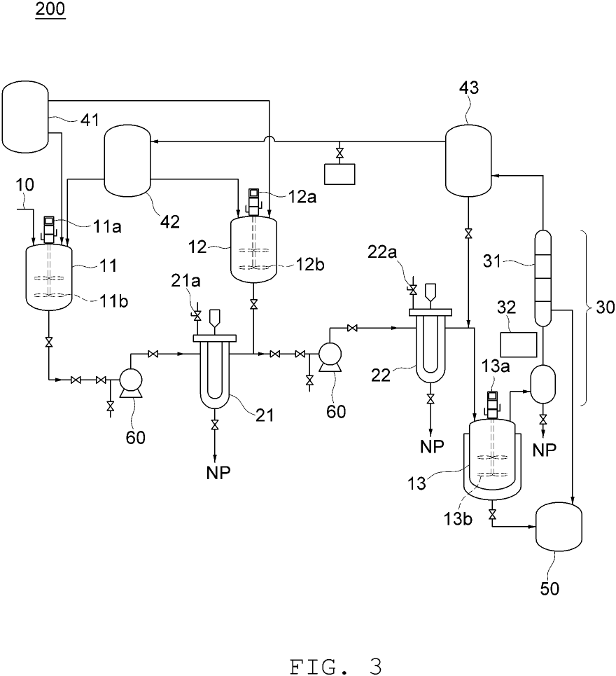

The nanoparticle purification system 100 may further include, although not illustrated in FIG. 1, a distillation device (30 in FIG. 3) for separating the mix solvent from the second filtrate supplied from the second continuous centrifuge 22. The distillation device 30 may use a method of distilling and separating a mix solvent of two or more components having different boiling points, and any conventional solvent distillation device or solvent purification device known in the art may be applied without limitation.

The nanoparticle purification system 100 may further include, although not illustrated in FIG. 1, at least one solvent storage tank (not illustrated) connected to the distillation device and storing the solvent recovered by distillation. The solvent storage tank may be connected to at least one of the plurality of solvent supply tanks 41 and 42, the first mix tank 11 and the second mix tank 12 to reuse the recovered solvent.

In addition, the nanoparticle purification system 100 may further include, although not illustrated in FIG. 1, at least one nanoparticle NP recovery container for collecting the nanoparticles collected from the first continuous centrifuge 21 and the second continuous centrifuge 22.

A size of the nanoparticles NP, for example, quantum dots (QD), recovered through the above-described mass purification system 100 is not particularly limited, and may be appropriately adjusted within a conventional range known in the art. For example, an average particle diameter (D₅₀) of the nanoparticles may be in a range of 1 to 20 nm, specifically in a range of 2 to 15 nm, more specifically in a range of 2 to 10 nm. When a particle diameter of the nanoparticles (e.g., quantum dots) is controlled to be approximately in a range of about 1 to 20 nm, light of a desired color may be emitted. In addition, a photoluminescence (PL) wavelength of the recovered nanoparticles NP may be controlled within a range of 2 to 4 nm. For example, when the photoluminescence (PL) of the desired nanoparticles is 538 nm, it may be controlled within a range of 538±2 nm, and specifically 538±1 nm. However, the present invention is not particularly limited to the above-described wavelength band, and may include all wavelength bands that nanoparticles may have in the art.

In addition, a shape of the recovered nanoparticles (e.g., quantum dots) is not particularly limited as long as it is a shape generally used in the art. For example, it may include all types of shapes such as spherical, rod, pyramidal, disk, multi-arm, or cubic nanoparticles, nanotubes, nanowires, nanofibers, and nanoplatelet particles.

Hereinafter, an operation of an embodiment of the nanoparticle purification method using the nanoparticle purification system of FIG. 1 described above will be described.

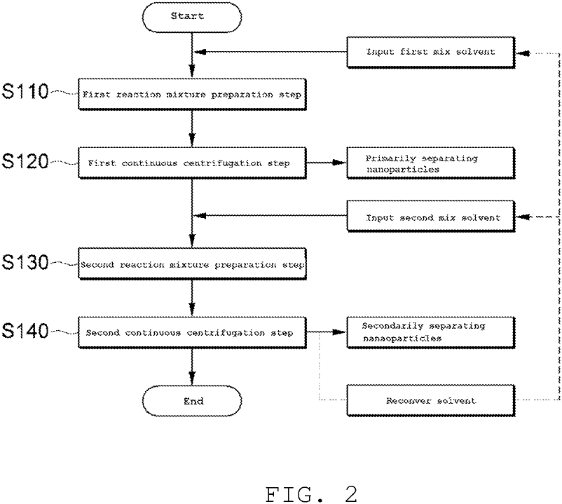

FIG. 2 is a schematic process flow chart illustrating a nanoparticle purification method according to an embodiment of the present invention.

Referring to FIG. 2, the nanoparticle purification method according to an embodiment of the present invention is a method for mass purifying nanoparticles in a continuous process and may include a first reaction mixture preparation step (S110), a first continuous centrifugation step (S120), a second reaction mixture preparation step (S130), and a second continuous centrifugation step (S140).

The first reaction mixture preparation step (S110) is a step of mixing the synthetic crude solution including nanoparticles NP and the first mix solvent.

In this step, the synthesis crude solution including the nanoparticles NP, a high boiling point solvent necessary for synthesizing the nanoparticles, and other substances is mixed with the first mix solvent including a non-solvent mix solvent, or a non-solvent and an organic solvent. That is, when the crude solution for nanoparticle synthesis and the first mix solvent are continuously supplied to the first mix tank, the crude solution for nanoparticle synthesis and the first mix solvent are uniformly mixed by the stirrer in the first mix tank, and thus the first reaction mixture is prepared and extracted.

The first mix solvent may be a non-solvent mixture in which the nanoparticles are not dispersible, or a mixture of a non-solvent and an organic solvent. An example thereof may be acetone and ethanol. In such a case, in order to improve quality of the nanoparticles to be purified, the first mix solvent may optionally further include an inorganic material.

The inorganic material is not particularly limited, and for example, a conventional metal halide known in the art, or a solution including a metal halide may be used.

The metal halide may not only help desorption of a weak ligand surrounding the nanoparticles (e.g., quantum dots) during the continuous centrifugation step (S120) to be described below, but also maintain and improve the quality of final nanoparticles (e.g., maintain the quantum efficiency of quantum dots) as a part of the halogen contained in the metal halide serves as a ligand of the nanoparticles. That is, the metal halide may desorb a part of an organic material (e.g., an organic ligand) present on a surface of the nanoparticles (e.g., quantum dots), and a cationic material (e.g., metal) and an anionic material (e.g., halogen) constituting the metal halide may each be bonded with the nanoparticle surface to substitute. In such a case, as the organic ligand layer is removed, a defect may occur on the surface of the quantum dots, and as the cationic material and the anionic material introduced by the metal halide may be bonded with the surface of the nanoparticles (e.g., quantum dots), additional defects of the nanoparticles may be suppressed. As such, it is possible to prevent in advance the organic ligand material present on the surface of the nanoparticles from acting as a limiting factor in various quantum dot applications.

The metal halide applicable in the present invention may refer to a conventional compound in which at least one metal and at least one halogen atom are ionically bonded, and specifically, may use without limitation a conventional compound including a metal selected from Group 1, Group 2, Group 3 metals and transition metals, and a halogen element selected from F, Cl, Br, and I. Specific examples of the metal halide may include zinc (Zn)-based halides such as ZnCl₂, ZnBr₂, and ZnI₂; magnesium (Mg)-based halides such as MgCl₂; and aluminum (Al)-based halides such as AlCl₃.

In addition, the solvent constituting the metal halidecontaining solution is not particularly limited, and a polar solvent, a non-polar solvent, or both of the polar and non-polar solvents known in the art capable of dissolving and/or dispersing the above-described metal halides may be used. For example, a polar solvent such as water may be used.

As a specific example, the inorganic material may be a metal halide including at least one of Zn, Mg, and Al, or an aqueous solution including the metal halide. More specifically, it may be an aqueous solution including a zinc-based halide (e.g., an aqueous solution including ZnCl₂).

In addition, an input amount of the inorganic material may be in a range of 1 to 10 percent by weight (wt%), specifically in a range of 2 to 10 wt%, with respect to the total weight (e.g., 100 wt%) of ethanol in the mix solvent. However, the present invention is not limited to the above-mentioned numerical value, and an amount of the inorganic material to be input may be appropriately adjusted in consideration of the quality of the nanoparticles.

As a specific example, a mixing ratio of the crude solution for nanoparticle synthesis, acetone and ethanol constituting the first reaction mixture may be adjusted to be in a range of 1 to 3 : 1 to 2 : 4 to 12 by volume, and specifically in a range of 1 to 3 : 1 : 4 to 12 by volume, and more specifically 3 : 1 : 6 by volume. When the mixing ratio of the first reaction mixture satisfies the above-described numerical range, it is possible to effectively remove the high boiling point solvent contained in the crude solution for nanoparticle synthesis, thereby increasing a recovery rate of nanoparticles.

Next, the first continuous centrifugation step (S120) is a step of primarily separating the nanoparticles NP and a solvent by performing centrifugation after continuously supplying and inputting the first reaction mixture into the first continuous centrifuge.

In order to purify high-purity nanoparticles at a high yield, in the first continuous centrifugation step (S120), it is necessary to control operating conditions of the continuous centrifuge within a predetermined range. Specifically, an input amount per minute of the first reaction mixture supplied to the first continuous centrifuge 21 may be in a range of 4 to 6 L/min, and specifically in a range of 4 to 5.5 L/min. It may be adjusted to 5 L/min according to tank conditions. A G value of the first continuous centrifuge 21 may be in a range of 13,000 to 16,000 g, specifically in a range of 14,000 to 16,000 g, and more specifically in a range of 13,600 to 15,600 g. A rotational speed may be in a range of 13,000 to 16,000 rpm, and specifically in a range of 14,000 to 16,000 rpm, and may be operated at a range of 50 to 60 Hz. An operating time of the first continuous centrifuge 21 is not particularly limited, and may be operated for 4 to 10 hours, and specifically 6 to 8 hours, in order to purify nanoparticles within a predetermined process time.

In the first continuous centrifugation step (S120), due to the characteristics of high-speed continuous centrifugation, fine mist of the organic solvent may be generated to cause, for example, fire and odor, and thus it is preferable to perform centrifugation in a state of supplying an inert gas, such as nitrogen gas (N₂ blowing), into the first continuous centrifuge. In such a case, an input amount of the inert gas is not particularly limited, and may be appropriately adjusted within a range known in the art.

When the first reaction mixture passes through the first continuous centrifuge 21, about 80 % of the synthesized nanoparticles NP are separated from the first filtrate and then recovered. In addition, a remaining amount of the nanoparticles corresponding to the other 20 % is transferred to the second mix tank 12 while being included in the first filtrate.

The second reaction mixture preparation step (S130) is a step of mixing the first filtrate that has undergone the first continuous centrifugation step (S120) and the second mix solvent.

That is, the first filtrate is continuously introduced through the inlet of the second mix tank 12 connected to the first continuous centrifuge 21, and the second mix solvent is input through another inlet of the second mix tank 12. As described above, the second mix solvent may include a mixture of a non-solvent, or include a non-solvent and an organic solvent, and for example, acetone and ethanol may be used. In addition, in consideration of the high quality of the recovered nanoparticles, 1 to 10 wt% of inorganic substances with respect to the total weight (e.g., 100 wt%) of ethanol in the second mix solvent may be further included. Specifically, an amount of the inorganic material used may be in a range of 2 to 10 wt%, and more specifically in a range of 3 to 10 wt%. In addition, as the inorganic material, zinc (Zn)-based halides, magnesium (Mg)-based halides, aluminum (Al)-based halides, or an aqueous solution of the metal halides thereof may be used.

In the second reaction mixture preparation step (S130), the mixing ratio of the first filtrate, acetone, and ethanol constituting the second reaction mixture may be in a range of 1 to 3 : 1 to 2 : 4 to 12 by volume, specifically in a range of 1 to 3 : 1 : 4 to 12 by volume, and more specifically 3 : 1 : 5 by volume. When the mixing ratio of the second reaction mixture satisfies the above-described numerical range, the second byproduct contained in the first filtrate may be effectively removed to further improve the recovery rate, purity and quality of the high-purity nanoparticles.

Then, in the second continuous centrifugation step (S140), the second reaction mixture is continuously supplied and added into the second continuous centrifuge 22 connected to the second mix tank 12, and then centrifugation is performed to secondarily separate the nanoparticles NP and a solvent.

Similar to the first continuous centrifugation step (S120), in the second continuous centrifugation step (S140), it is necessary to adjust operating conditions of the continuous centrifuge to a predetermined range. Specifically, an input amount per minute of the first filtrate supplied to the second continuous centrifuge 22 may be in a range of 4 to 6 L/min, and specifically in a range of 4 to 5 L/min, which may be adjusted to 5 L/min depending on tank conditions. In addition, a G value of the second continuous centrifuge 21 may be in a range of 13,000 to 16,000 g, specifically in a range of 14,000 to 16,000 g, and more specifically in a range of 13,611 to 15,625 g. A rotational speed may be in a range of 13,000 to 16,000 rpm, and specifically in a range of 14,000 to 16,000 rpm, and may be operated at a range of 50 to 60 Hz. An operating time of the second continuous centrifuge 22 is not particularly limited, and may be operated for 2 to 8 hours, specifically 3 to 7 hours, and more specifically 4 to 6 hours, in order to purify nanoparticles within a predetermined process time.

If necessary, the purification method may further include: a step of recovering a solvent from a secondary filtrate that has undergone the second continuous centrifugation step (S140); and reusing the recovered solvent as a raw material for the first mix solvent or the second mix solvent.

In such a case, a method for recovering the solvent is not particularly limited, and a conventional solvent recovery method known in the art, for example, distillation, and the like may be used. In addition, the recovered solvent or the solvent stored in the solvent supply tanks 41 and 42 or the solvent storage tank 43 may be reused after performing a purity check (e.g., quality control (QC) test).

FIG. 3 is a schematic diagram illustrating a nanoparticle purification system 200 according to another embodiment of the present invention. In FIG. 3, the same reference numerals as those of FIG. 1 denote the same members.

Hereinafter, in the description of FIG. 3, description described with respect to FIG. 1 will not be described again, and only differences will be described. Referring to FIG. 3, a nanoparticle purification system 200 according to an embodiment of the present invention further includes at least one of a third mix tank 13, a distillation device 30, and a solvent storage tank 43. and preferably includes all of them 13, 30, and 43.

The third mix tank 13 prepares a third reaction mixture by uniformly mixing the second filtrate filtered from the second continuous centrifuge 22, and a third mix solvent. For the third mix tank 13, the description of the first mix tank 11 and the second mix tank 12 described above may be applied as it is.

As the third solvent input to the third mix tank 13, the first and/or second mix solvent may be used, or one single solvent thereof may be used. As an example, ethanol may be used. In addition, a mixing ratio of the second filtrate and the third solvent is not particularly limited, and may be, for example, in a range of 1 to 2 : 4 to 10 by volume, and specifically in a range of 1 : 4 to 10 by volume.

The third reaction mixture uniformly mixed in the third mix tank 13 is transferred to the distillation device 30 and then tertiarily separated into the nanoparticles NP and a solvent through distillation.

The distillation device 30 is a device for distilling and separating a mix solvent of two or more components having different boiling points, and a conventional solvent distillation device or solvent purification device known in the art may be used without limitation. For example, the distillation device 30 may include a distillation heat exchanger 31 into which the second filtrate is supplied; and at least one heater 32 disposed in contact with the distillation heat exchanger 31. The distillation heat exchanger 31 may use a glass or a metal material.

The nanoparticle purification system 200 according to the present invention further includes at least one solvent storage tank 43 connected to the distillation device 30 and configured to store a solvent recovered by distillation. The solvent storage tank 43 may be connected to at least one of the plurality of solvent supply tanks 41 and 42, the first mix tank 11, the second mix tank 12, and the third mix tank 13 and may use a recovered solvent. In such a case, the recovered solvent or the solvent stored in the solvent supply tanks 41 and 42 and/or the solvent storage tank 43 may be reused after performing a purity test (e.g., quality control (QC) test) of the solvent, if necessary.

As for the description of the configuration or structure of each component in the nanoparticle purification system 200 of FIG. 3, the description of the nanoparticle purification system 100 according to an embodiment of FIG. 1 may be applied as it is.

Hereinafter, an operation of an embodiment of a nanoparticle purification method using the nanoparticle purification system of FIG. 3 described above will be described.

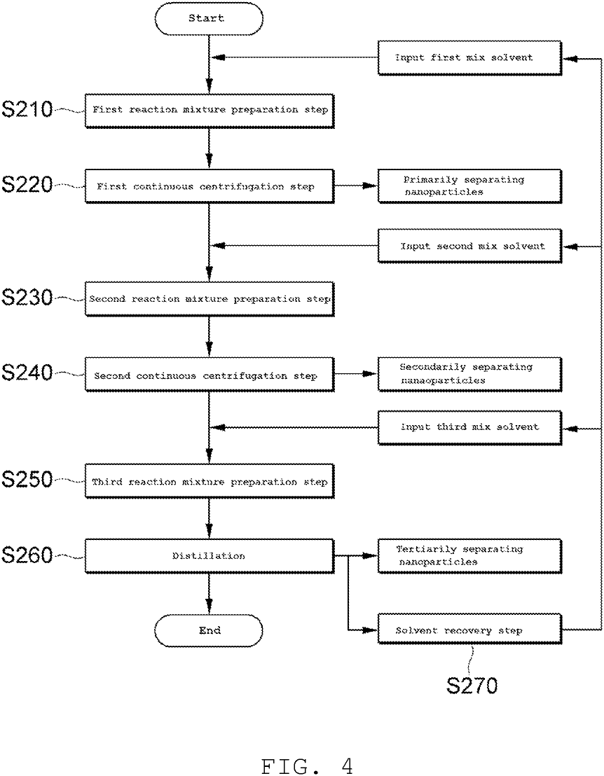

FIG. 4 is a schematic process flow chart illustrating a nanoparticle purification method according to another embodiment of the present invention. Hereinafter, in the description of FIG. 4, description described above with respect to FIG. 2 will not be described again, and only differences will be described.

Referring to FIG. 4, the nanoparticle purification method according to another embodiment of the present invention may further include a third reaction mixture preparation step (S250), a nanoparticle and solvent separation step through distillation (S260), and a solvent recovery and reuse step (S270).

The third reaction mixture preparation step (S250) is a step of mixing the second filtrate that has undergone the second continuous centrifugation step (S240), and the third solvent.

As the third solvent, the aforementioned first and/or second mix solvent may be used, or one single solvent thereof may be used, and specifically, ethanol may be preferably used. In addition, a mixing ratio of the second filtrate and the third solvent may be in a range of 1 to 2 : 4 to 10 by volume, and specifically in a range of 1 : 4 to 10 by volume, but the present invention is not particularly limited thereto.

Next, in the distillation step (S260), the third reaction mixture is transferred to the distillation device 30 connected to the third mix tank 13, and then the nanoparticles NP and a solvent are tertiarily separated through distillation. In such a case, the distillation method is not particularly limited, and a method of separating two or more solvents having different boiling points may be used.

After the distillation step (S260), residual nanoparticles NP contained in the second filtrate are recovered by tertiary separation, and the mix solvent is sequentially separated according to their unique boiling points (b.p) and transferred to the storage tank 43 for each solvent component. The solvent thus recovered may be reused in at least one of, or all of, the first reaction mixture preparation step (S210), the second reaction mixture preparation step (S230), and the third reaction mixture preparation step (S250). In addition, before reusing the solvent, if necessary, a purity check (e.g., quality control (QC) test) of the solvent may be performed in advance.

In addition, the description for the nanoparticle purification method of FIG. 2 described above according to an embodiment may be applied as it is in the description for each manufacturing step in the nanoparticle purification method of FIG. 4.

As described above, the nanoparticle purification system according to the present invention may include at least two continuous centrifuges and optimize the mixing ratio between the solvent and the non-solvent and the centrifugation conditions through fine control, thereby purifying and recovering the nanoparticles of the desired photoluminescence wavelength band with high purity at high yield. In addition, in the present invention, since the used solvent may be recovered and reused, it is useful, economical, and environmentally friendly in terms of organic wastewater treatment, even when a continuous centrifuge using a relatively large amount of an organic solvent is used a plurality of times.

Hereinafter, the present invention will be described in more detail through examples. These examples are only for illustrating the present invention in more detail, and it will be apparent to those skilled in the art that the scope of the present invention is not limited by these examples, based on the gist of the present invention.

### Experimental Example 1: Evaluation of Reaction Conditions of The First Mix Tank

A purification process was performed by changing a mixing ratio (volume ratio) of a crude solution for nanoparticle synthesis (including a high boiling point solvent) and a non-solvent first mix solvent, which constitute a first reaction mixture, as illustrated in Table 1 below, and a recovery rate was evaluated.

TABLE 1

| First mix tank conditions | Ex. 1 | Ex. 2 | Ex. 3 | Ex. 4 | Ex. 5 |
|---|---|---|---|---|---|
| Crude solution for nanoparticle synthesis : Acetone : Ethanol | 3 : 1 : 6 | 3 : 1 : 3 | 3 : 1 : 4 | 3 : 1 : 5 | 3 : 1 : 7 |
| Recovery (%) | 97% | 80% | 88% | 92% | 97% |

As shown in Table 1 above, it was appreciated that by finely controlling the mixing ratio of the solvent and the non-solvent within a predetermined range, the recovery rate of nanoparticles may be highly controlled.

In such a case, Example 5 showed the same numerical value as in Example 1 in terms of the recovery rate of the nanoparticles, but an amount of ethanol used is relatively large. As such, when a large amount of ethanol is used, a yield of nanoparticles may be slightly increased, but the photoluminescence (PL) of the recovered nanoparticles may be out of the desired wavelength range, resulting in a decrease in the quality of nanoparticles (e.g., decrease in quantum efficiency). In addition, the cost may increase due to the increase in the amount of ethanol used.

### Experimental Example 2: Evaluation of Reaction Conditions of the First Continuous Centrifuge

After fixing a mixing ratio (volume ratio) of a crude solution for nanoparticle synthesis (reaction solution): acetone: ethanol of the first reaction mixture to 3 : 1 : 6, process conditions (e.g., G value, rotation speed) of the first continuous centrifuge to which the first reaction mixture is transferred were changed as shown in Table 2 below to perform the nanoparticle purification process.

TABLE 2

| Conditions | Ex. 6 | Comp. Ex. 1 | Comp. Ex. 2 | Comp. Ex. 3 | Comp. Ex. 4 |
|---|---|---|---|---|---|
| G value | 15, 000 | 12, 500 | 10, 000 | 7, 500 | 5, 000 |
| Rotation speed (rpm) | 16, 000 | 13, 300 | 11, 100 | 9, 300 | 7, 700 |
| Recovery (%) | 97% | 95% | 93% | 88% | 75% |

As shown in Tables 1 and 2, in the present invention, the purification system capable of recovering nanoparticles at high yield from a large amount of a crude solution for nanoparticle synthesis was established, and purification conditions for optimizing the mass purification system was confirmed.

Reference numerals

| | |
|---|---|
| 100, 200: | nanoparticle purification system |
| 10: | crude solution for nanoparticle synthesis |
| 11, 12, 13: | mix tank |
| 11a, 12a, 13a: | motor |
| 11b, 12b, 13b | stirrer |
| 21, 22: | continuous centrifuge |
| 21a, 22a: | inert gas supply |
| 30: | distillation device |
| 31: | distillation heat exchanger |
| 32: | heater |
| 41, 42: | solvent supply tank |
| 43: | solvent storage tank |
| 50: | waste tank |
| 60: | transfer pump |

1. A system of purifying nanoparticles, the system comprising:
a first mix tank configured to prepare a first reaction mixture by mixing a crude solution for nanoparticle synthesis and a first mix solvent;
a first continuous centrifuge configured to primarily separate nanoparticles and a first filtrate by centrifuging the first reaction mixture supplied from the first mix tank;
a second mix tank configured to prepare a second reaction mixture by mixing the first filtrate supplied from the first continuous centrifuge and a second mix solvent; and
a second continuous centrifuge configured to secondarily separate the nanoparticles and a second filtrate by centrifuging the second reaction mixture supplied from the second mix tank.

2. The system of purifying nanoparticles of claim 1, further comprising:
a third mix tank configured to prepare a third reaction mixture by mixing the second filtrate supplied from the second continuous centrifuge and a third mix solvent.

3. The system of purifying nanoparticles of claim 2, further comprising:
a distillation device configured to separate, in a distillation manner, a mix solvent and the nanoparticles from the third reaction mixture of the third mix tank or from the second filtrate separated by the second continuous centrifuge.

4. The system of purifying nanoparticles of claim 3, wherein the distillation device comprises:
a distillation heat exchanger into which the third reaction mixture or the second filtrate is supplied; and
at least one heater disposed in contact with the distillation heat exchanger.

5. The system of purifying nanoparticles of claim 3, further comprising at least one solvent storage tank connected to the distillation device and configured to store a solvent recovered by distillation.

6. The system of purifying nanoparticles of claim 5, further comprising a plurality of solvent supply tanks,
wherein the solvent storage tank is connected to at least one of the plurality of solvent supply tanks and the first to third mix tanks such that the recovered solvent is reused.

7. The system of purifying nanoparticles of claim 1, further comprising a monitoring unit installed at a predetermined position in a pipe where the first continuous centrifuge and the second mix tank are connected.

8. The system of purifying nanoparticles of claim 1, wherein each of the first continuous centrifuge and the second continuous centrifuge includes an inert gas supply for supplying an inert gas into the first continuous centrifuge and the second continuous centrifuge.

9. A method of purifying nanoparticles, the method comprising:
(i) preparing a first reaction mixture by mixing a crude solution for nanoparticle synthesis and a first mix solvent;
(ii) primarily separating nanoparticles and a first filtrate from the first reaction mixture using a continuous centrifuge;
(iii) preparing a second reaction mixture by mixing the first filtrate and a second mix solvent; and
(iv) secondarily separating the nanoparticles and a second filtrate from the second reaction mixture using a continuous centrifuge.

10. The method of claim 9, wherein in step (i), the crude solution for nanoparticle synthesis comprises the nanoparticles and a high boiling point solvent.

11. The method of claim 9, wherein each of the first mix solvent and the second mix solvent is a mixture of a non-solvent in which the nanoparticles are not dispersible, or a mixture of a non-solvent and an organic solvent.

12. The method of claim 9, wherein each of the first mix solvent and the second mix solvent is a mixture of acetone and ethanol.

13. The method of claim 12, wherein in the first reaction mixture in step (i), a mixing ratio of the crude solution for nanoparticle synthesis, acetone and ethanol is in a range of 1 to 4 : 1 to 2 : 4 to 12 by volume.

14. The method of claim 12, wherein in the second reaction mixture in step (iii), a mixing ratio of the first filtrate, acetone and ethanol is in a range of 1 to 3 : 1 to 2 : 4 to 12 by volume.

15. The method of claim 9, wherein the first mix solvent in step (i) or the second mix solvent in step (iii) further comprises 1 to 10 percent by weight (wt%) of an inorganic material with respect to the total weight of ethanol in the corresponding mix solvent.

16. The method of claim 15, wherein the inorganic material is a metal halide comprising at least one of Zn, Mg, and Al, or an aqueous solution comprising the metal halide.

17. The method of claim 9, wherein the continuous centrifuges in steps (ii) and (iv) are operated under conditions of:
a reaction mixture input amount per minute in a range of 4 to 6 L/min;
a G value in a range of 13,000 to 16,000 g; and
a rotational speed in a range of 13,000 to 16,000 rpm.

18. The method of claim 9, wherein each of the first continuous centrifuge and the second continuous centrifuge centrifuges under an inert atmosphere by supplying a nitrogen gas into each of the first continuous centrifuge and the second continuous centrifuge.

19. The method of claim 9, further comprising, after step (iv):
(v) preparing a third reaction mixture by mixing the second filtrate and a third solvent; and
(vi) tertiarily separating the nanoparticles and a solvent by distilling the third reaction mixture.

20. The method of claim 19, further comprising, after step (vi):
(vii) recovering the separated solvent and reusing the recovered solvent as a solvent of at least one of steps (i), (iii) and (v).
